(19) United States
(12) Patent Application Publication
(10) Pub. No.: US 2004/0158462 A1
(43) Pub. Date: Aug. 12, 2004

(54) Pitch candidate selection method for multi-channel pitch detectors

(76) Inventors: Glen J. Rutledge, Brentwood Bay (CA); Peter Lupini, Victoria (CA); Andrew Fort, Leuven (BE)

Correspondence Address: WILSON SONSINI GOODRICH & ROSATI, 650 PAGE MILL ROAD, PALO ALTO, CA, 943041050

(21) Appl. No.: 10/480,690

(22) PCT Filed: Jun. 11, 2001
(86) PCT No.: PCT/CA01/00860

(51) Int. Cl. G10L 11/04

(52) U.S. Cl. 704/207

(57) ABSTRACT

An improved method of performing channel selection in multi-channel pitch detection systems. For each channel, several features are computed using the input signal and the value of the pitch candidate from the channel. The resulting feature vector is used to evaluate a multi-variate likelihood function which defines the likelihood that the pitch candidate represents the correct pitch. The final pitch estimate is then taken to be the pitch candidate with the highest likelihood of being correct, or the mean (or median) of the pitch candidates with likelihoods above a given threshold. The functional form of the likelihood function can be defined using several different parametric representations, and the parameters of the likelihood function can be advantageously derived in an automated manner using signals having pitch labels that are considered to be correct. This represents a significant improvement over previous channel selection methods where the parameters are chosen laboriously by hand.

### TECHNICAL FIELD OF INVENTION

This invention relates generally to the digital analysis of signals from human speech, the human singing voice, and musical instruments and, more particularly, to the accurate and robust estimation of the pitch of said signals.

### BACKGROUND OF INVENTION

Estimating the pitch of a signal is an important task in several technical fields, including the digital storage and communication of speech, voice processing and musical processing. The pitch period of a signal is the fundamental period of the signal, or in other words, the time interval on which the signal repeats itself. The pitch frequency is the inverse of the pitch period, which is the fundamental frequency of a signal. Pitch detection is the process of estimating the pitch of a signal based on measurements made on the signal waveform.

Due to the large number of applications that require accurate and robust pitch detection, there is a significant amount of background art in this area. With few exceptions, most of the fundamental methods of pitch detection have been summarized by W. Hess, Pitch Determination of Speech Signals: Algorithms and Devices, Springer Series in Information Sciences, Springer-Verlag, 1983.

A pitch detection algorithm (PDA) can be represented in generic form as shown in FIG. 1. The Preprocessor block may include linear, non-linear or adaptive filtering, and other forms of data reduction. For short-term PDAs, the preprocessor also includes a short-term analysis of a windowed portion of the signal, which represents the signal in a form that makes it easier for the basic extractor to estimate a pitch. The Basic Extractor block is responsible for coming up with a pitch estimate based on the preprocessed signal. The pitch estimate can be in the form of epoch markers which indicate the start of each pitch period in the signal, which is typical of time domain PDAs, or alternatively, it may be given as an average pitch period over a short time segment, which is typical of short-term analysis PDAs. The Postprocessor block is responsible for correcting, smoothing, and converting the pitch estimate into a form that is suitable for a given application.

A generalization of the generic PDA shown in FIG. 1 is the multi-channel PDA, which is shown in FIG. 2. In this form, the PDA consists of several channels, each of which computes a pitch estimate independently. The final block titled Channel Selection then chooses which channel represents the “correct” pitch. The individual channels may be different in only a subset of the three generic blocks (e.g. preprocessor only), or they may be completely unique algorithms that differ in each generic block.

The motivation for using a multi-channel pitch detection strategy was described by B. Gold, Description of a computer program for pitch detection, in A. K. Nielsen, editor, Congress Report, 4th International Congress on Acoustics, G34, p 917, Kopenhagen, 1962, Harlang and Toksvig, Kopenhagen, as:

Designers of pitch detectors have, of course, tried to make their circuits simple, and, to that end, have usually tried to find the one operation which will give a good pitch indication. There is serious doubt, however, as to whether any one rule will suffice to weed out the pitch from as complicated a waveform as speech.

This observation was corroborated by an in-depth comparison of several pitch detection methods by L. R. Rabiner, M. J. Cheng, A. E. Rosenberg, and C. A. McGonegal, A comparative performance study of several pitch detection algorithms, IEEE Transactions on Acoustics, Speech and Signal Processing, ASSP-24: 399417, October 1976, who concluded that there was not a single pitch detection algorithm that out-performed all the others, but rather, they concluded that the performance of each pitch detection algorithm was significantly dependent on the characteristics of the signal being analyzed.

Multi-channel PDAs can be categorized as follows:

Main-auxiliary PDA—A two channel PDA, where the main channel uses a robust but inaccurate PDA to obtain a rough estimate of the pitch, and the auxiliary channel uses a non-robust but accurate PDA that requires the rough pitch estimate of the Main channel PDA to operate satisfactorily.

Subrange PDA—Multiple channels operate on different frequency subranges, which allows the PDA to operate over a wide frequency range while keeping the individual channel PDAs relatively simple.

Multi-principle PDA—Each channel uses a PDA that operates under a different principle by using an independent method or the same method with different parameters for one or more of the three generic blocks. The channel PDAs will perform better for different types of signals, and thus will make errors at different times. In theory, this approach can reduce the total number of errors, provided that at least one of the channels contains the correct pitch, and the channel selection algorithm selects the right channel.

The Channel Selection block plays a key role in multi-channel PDAs. For Main-Auxiliary PDAs, the channel selection block generally selects the pitch from the auxiliary channel if it is available, and otherwise chooses the pitch from the main channel, so the algorithm is relatively uncomplicated. For Subrange PDA, the channel selection block generally uses the minimum-frequency selection principle, which simply chooses the pitch from the lowest frequency band that has a signal level above a given threshold. The channel selection block for the Multi-principle PDA are considerably more involved, so several approaches will be discussed individually.

Multi-principle PDAs can also be viewed as a form of global error reduction. Generally speaking, there are two categories of pitch errors that will be referred to, namely gross pitch errors and fine pitch errors. Gross pitch errors are defined as errors where the difference between the estimated pitch and the correct pitch is considerably large. The most common gross pitch errors occur when the pitch period estimate is double (i.e. pitch doubling) or half (i.e. pitch halving) the correct pitch period, which will collectively be referred to as octave errors. Fine pitch errors are defined as errors where the difference between the estimated pitch and the correct pitch are considerably small, and are usually caused by random errors and limited pitch resolution in the system. One of the first Multi-principle PDAs was introduced by B. Gold, Computer program for pitch extraction, Journal of the Acoustical Society of America, 34:916921, 1962, and B. Gold, Description of a computer program for pitch detection. in A. K. Nielsen, editor, Congress Report, 4th International Congress on Acoustics, page G34, Kopenhagen, 1962, Harlang and Toksvig, Kopenhagen, which was later developed more thoroughly by. B. Gold and L. Rabiner, Parallel processing techniques for estimating pitch periods of speech in the time domain, The Journal of the Acoustical Society of America, 46(2 -part 2):442448, 1969. In this technique, six parallel time domain pitch detectors are used and channel selection is based on a heuristic algorithm that uses a matrix of past pitch estimates and their sums. This form of channel selection is primarily intended to reduce gross pitch errors caused by octave errors.

A related prior art method that is aimed at reducing both the gross and fine pitch errors by using a multi-principle PDA was disclosed by. J. Picone and D. Prezas, Parallel processing pitch detector, U.S. Pat. No. 4,879,748, November 1989. This method uses four parallel time domain pitch detectors, each with a different preprocessor block. Their channel selection method is quite complicated, involving four different consistency checks, an averaging component to reduce fine pitch errors that discards the highest and lowest pitch, and a tracking component that ensures that the current pitch estimate is congruent with past pitch estimates.

There are several multi-principle PDAs that use expected smoothness properties of the pitch trajectory in the channel selection process. W. R. Bauer and W. A. Blankinship, Process for extracting pitch information, U.S. Pat. No. 4,004,096, Jan. 18, 1977, use dynamic programming to find the optimal path through a matrix of pitch candidates as a function of time. G. R. Doddington and B. G. Secrest, Voice messaging system With unified pitch and voice tracking, U.S. Pat. No. 4,696,038, September 1987, use a similar dynamic programming method but they also find optimal voicing transitions (i.e. transitions in the signal from a section where pitch information exists to a section where pitch information does not exist, or vice versa). K. Swaminathan and M. Vemuganti, Robust pitch estimation method and device for telephone speech, U.S. Pat. No. 5,704,000, December 1997, have developed another algorithm for finding the optimal pitch contour from a matrix of pitch candidates as a function of time. K. Nakata and T. Miyamoto, Method and apparatus for extracting speech pitch, U.S. Pat. No. 4,653,098, March 1987, use the average of past pitch estimates as a guide for selecting the current pitch estimate.

Another method of selecting the correct pitch from multiple pitch candidates is to use an analysis by synthesis method (see for example S. Yeldener, Method and apparatus for pitch estimation using perception based analysis by synthesis, U.S. Pat. No. 5,999,897, December 1999). A synthetic signal, either in the time domain or the frequency domain, is generated using each pitch candidate. These signals are then compared to the original signal to obtain a measure of the error (or similarity) between the two signals and the pitch corresponding to the signal with the smallest error is chosen to be the correct pitch. The problem with this method is that signals synthesized with pitch frequencies that are integer multiples of the correct pitch frequency also result in a low error, and sometimes are selected as the correct pitch.

A potential solution to this problem was proposed by Y. Cho and M. Kim, Pitch estimation method for a low delay multiband excitation vocoder allowing the removal of pitch error without using a pitch tracking method, U.S. Pat. No. 6,119,081, September 2000, in which a weight for each pitch was defined using the flattened spectral covariance at a lag defined by the pitch candidate. The weight is close to zero when the signal is positively correlated and close to one when it is negatively correlated. They multiply the error signal by the weight signal for each pitch candidate to produce a new measure, such that the pitch candidate corresponding to the lo minimum of this new measure is selected as the pitch estimate. This method is primarily intended to reduce the number of gross pitch errors. It fails to work satisfactorily however for many low pitched speakers, especially if they have breathy or raspy voices, since magnitude spectra of such speakers are noisy and show many closely spaced harmonics, which results in a noisy is multi-peaked spectral covariance measure.

Since multi-principle PDAs can also be viewed as a method of error-reduction, we will also review several prior art methods in this area. A method for reducing gross pitch errors due to pitch doubling in a correlation-based pitch detector was disclosed by. J. G. Bartkowiak, System and method for error correction in a correlation-based pitch estimator, U.S. Pat. No. 5,864,795, Jan. 26, 1999 This invention involves doing heuristic checks to determine if a pitch candidate has a related peak at half its pitch value, which allows the pitch detector to avoid some potential pitch doubling errors. A similar prior art method was disclosed by J. G. Bartkowiak and M. Ireton, System and method for performing pitch estimation and error checking on low estimated pitch values in a correlation based pitch estimator, U.S. Pat. No. 5,774,836, Jun. 30, 1998, to avoid gross pitch errors caused by the first formant contribution in correlation-based pitch detectors. If a pitch candidate is found to have a suspiciously low value, then several checks are performed to ascertain whether the pitch candidate could be caused by the first formant, and if so, it is rejected. Both of these proposed methods are completely heuristic, in that the checks that are performed, and the parameters associated with these checks are chosen for particular signal types. These checks fail to provide a robust method of avoiding gross pitch errors for all signal types.

In summary, pitch detection algorithms can be generically described using three blocks, a Preprocessor, a Basic Extractor, and a Postprocessor. A multi-channel PDA consists of several individual PDAs operating in parallel with a Channel Selection block at the end that chooses the final pitch estimate to be one of the individual channel pitch estimates. Subcategories of multi-channel PDAs consist of Main-auxiliary PDAs, Subrange PDAs, and Multi-principle PDAs. Several channel selection algorithms were reviewed for multi-channel PDAs, which can be categorized into methods that use heuristic algorithms, methods that use pitch trajectories, and methods that 5 use a weighting function. Additionally, heuristic methods for reducing gross pitch errors were also presented.

The main problem with the current state of the art channel selection methods is that they are heuristic in nature and require many parameters to be adjusted manually to obtain acceptable performance. The fact that the parameters must be adjusted manually has also prevented channel selection methods from using multivariate features to determine the correct pitch channel since the possibly complex dependencies between features is generally too difficult to account for by manual methods.

The object of the current invention is to improve the channel selection as process for multi-channel PDAs by reducing the number of gross and fine pitch errors. A further object of this invention is to define a PDA in which a substantial number of the parameters can be estimated from correctly pitch labelled signals. This will allow the same basic PDA to be tuned for specific purposes without a lot of human intervention.

### SUMMARY OF INVENTION

The current invention improves on current channel selection methods in multi-channel PDAs by formulating the problem in such a way that correctly pitch labelled data can be used to estimate the majority of the parameters of the system. In this way, multivariate dependencies can easily be modelled between channel selection features which generally leads to an overall lower pitch error rate. In addition, by using correctly pitch labelled data from specific groups of people (including a single individual), the system can be quickly tuned to perform with a substantially lower pitch error rate for that specific group.

### BRIEF DESCRIPTION OF THE DRAWINGS

FIG. 1 (Prior Art) A block diagram of a generic pitch detection algorithm.

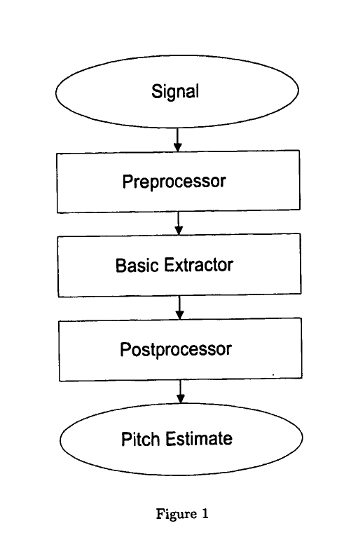

FIG. 2 (Prior Art) A block diagram of a multi-channel pitch detection algorithm.

FIG. 3 A block diagram showing an overview of the current invention.

FIG. 4 A block diagram showing a cepstral method of extracting pitch candidates.

FIG. 5 A block diagram showing the batch mode training for estimating the parameters of the likelihood function.

FIG. 6 A block diagram showing the adaptive mode training for estimating the parameters of the likelihood function.

### DETAILED DESCRIPTION OF THE PREFERRED EMBODIMENT

This invention will be described in the form of a real-time pitch detection algorithm for the singing voice. However, it should be clear to persons skilled in the art that the ideas presented are not restricted to such an application. Likewise, the specific parameter values used were chosen because they produced favorable results, but they should not be interpreted as being critical to the invention, since a person skilled in the art will readily acknowledge is that other parameter values may produce equal or better results depending on the application.

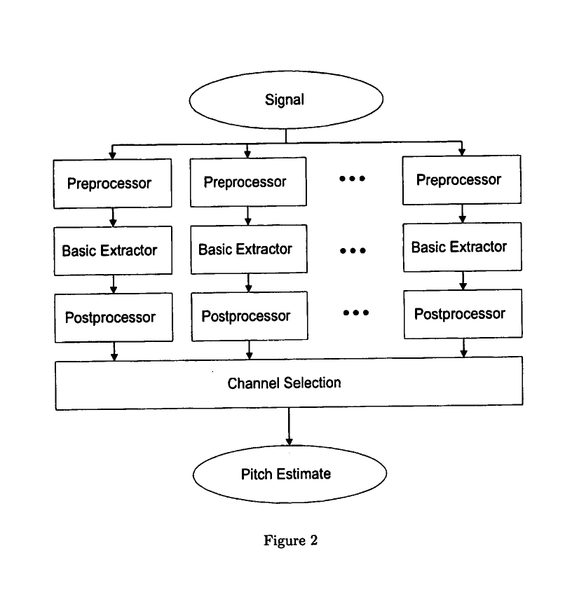

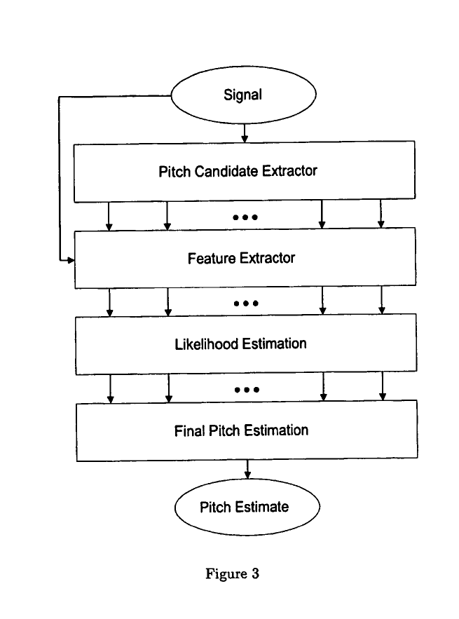

A summary diagram of the invention is presented in FIG. 3. The first block titled Pitch Candidate Extractor is identical to the multi-channel PDA shown in FIG. 2 without the channel selection block, such that each channel produces an individual pitch candidate. The next three blocks define an improved method of performing channel selection, which is the basis of the current invention.

The second block Feature Extractor computes a feature vector for each pitch candidate using the original signal. That is, several measures of the signal are made, which can be dependent on the value of the pitch candidate, the type of channel PDA that is employed or can be computed identically for each channel. The same measurements are made for each channel, so equal length feature vectors are produced. These features can also contain information from past and future (if the delay can be endured) pitch estimates, which allows important information relating to the smoothness of pitch contours to be incorporated into the system.

The third block titled Likelihood Estimation evaluates a multivariate likelihood function at the position given by each of the pitch candidate's feature vectors, which estimates how likely it is that each of the pitch candidates are correct. The functional form of the likelihood function can be defined in many ways, and the parameters of the likelihood function can be defined using expert knowledge or preferably by using correctly labelled training data and a suitable learning algorithm.

The fourth block titled Final Pitch Estimator determines the final pitch estimate based on the individual pitch candidates and the likelihood that they are correct. One option is to choose the pitch candidate that is most likely to be correct, but this approach will only remove gross pitch errors in the system. A better approach is to reject all pitch candidates that are below a given likelihood, which removes the gross pitch errors and then average or take the median of the remaining pitch candidates, which reduces the fine pitch errors.

Pitch Candidate Extractor

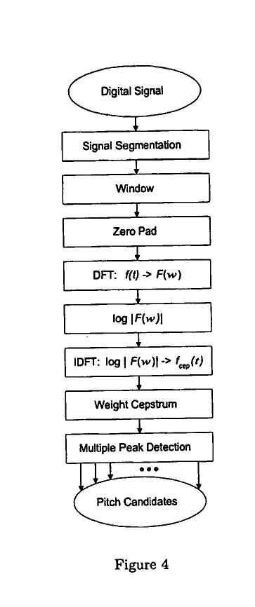

FIG. 4 shows the pitch candidate extractor used for this specific application. Starting with a digital signal sampled at 5.5 kHz and linearly quantized to 16 bits, the Signal Segmentation block frames the signal into is 30 ms (165 sample) frames with an overlap of 15 ms (82 samples). The Window block then applies a Hanning window weighting function to the time domain signals in each frame. The Zero Pad block adds 91 zeros to the end of each frame to give each frame a length of 256. The zeros are added to allow the fast Fourier Transform (FFT) algorithm to be used for the computation of the discrete Fourier transform (DFT), which requires that the signal length be an integer power of two. This zero padding operation also increases the resolution of the DFT spectra.

The cepstrum of each frame is then computed as follows. The DFT block transforms the time domain signal ƒ(t) into a complex frequency domain signal F(ω) using the discrete Fourier transform. The Log block discards the phase spectrum and computes the log of the magnitude spectrum. This spectrum has a length of 256, but it is symmetrical about the middle of the spectrum, so only 128 samples are unique. The IDFT block transforms the log magnitude spectrum log |F(ω)| into the cepstrum ƒ_{cep}(τ). The domain of the cepstrum is called quefrency which is a measure of time. Peaks in the cepstrum correspond to periodic components in the log magnitude spectrum, which in turn correspond to harmonically related tones in the time domain signal. The position of the peak in quefrency indicates the average separation between the harmonics, which also indicates the pitch period for periodic signals.

For the human singing voice, the typical range of expected pitch period is between 1 ms and 15 ms, which corresponds approximately to samples 5 and 83 respectively in the cepstrum. Also, the cepstrum produces larger peaks for lower pitch periods due to the larger number of pitch periods that fit in the signal frame. Therefore, the Weight Cepstrum block multiplies a weighting function with the cepstrum that has the following properties. The weight function is zero below 1 ms and above 15 ms, and is a linear function between 1 ms and 15 ms given by ω=mτ+1, where m=0.43, and τ is the quefrency in ms.

The Multiple Peak Detection block then finds up to five peaks in the cepstrum as follows. First, the largest 3 peaks are selected, and then the two peaks with the lowest quefrency are selected if they have not already been selected. The net result is that between three and five pitch candidates are selected for each frame located at time tₙ, which will be referred to as {τ₁(tₙ), τ₂(tₙ), . . . τ_{Q}(tₙ)}, where Q is the total number of pitch candidates.

This approach can be viewed as a multi-channel PDA, where the only difference between the channels is the final peak selection process. However, it should be emphasized that the pitch candidates could be chosen using different parameters for the cepstral pitch extractor (e.g. window size), or even by using an entirely different method, such as picking peaks from the short-time autocorrelation function.

Feature Extractor

The feature extractor extracts several features for each pitch candidate from the original signal based on the value of the individual pitch candidates. The feature extraction process is critical to the successful operation of the current invention. Some considerations that should be made when choosing features are as follows

Features must be normalized to account for differences in pitch, signal energy, etc.

Features should require little if any branching logic for optimal performance on a digital signal processor (if the algorithm is to operate in real-time).

The combination of features chosen must separate correct pitch candidates from incorrect pitch candidates.

The features used for this specific application are as follows:

Cepstral Peak Size The weighted cepstral value at the quefrency given by the pitch candidate period divided by the largest weighted cepstral value. In general, the larger the peak size, the more likely the candidate is the correct pitch. This is not strictly true for noisy signals, and signals with significant amplitude modulation, so errors would still occur if this was the only feature used.

Rahmonic I Peak Size The weighted cepstral value of the largest peak between 80% and 120% of the quefrency given by two times the pitch candidate period, divided by the largest weighted cepstral value. Pitch candidates corresponding to the correct pitch will tend to have large values for this feature compared to pitch candidates corresponding to the incorrect pitch.

Rahmonic II Peak Size The weighted cepstral value of the largest peak between 80% and 120% of the quefrency given by three times the pitch candidate period, divided by the largest weighted cepstral value. Pitch candidates corresponding to the correct pitch will tend to have large values for this feature compared to pitch candidates corresponding to the incorrect pitch.

These features were chosen based on expert knowledge derived from visual inspection of a multitude of cepstral signals. All the features were chosen from the cepstral domain for efficiency reasons. It should be clear to one skilled in the art that a multitude of other features are also possible, which may be derived from a domain other than the cepstral domain.

For example, features could be derived from the frequency domain by employing the log magnitude spectrum log |F(ω)|, which was computed as an intermediate step in the cepstrum computation described aboveA feature could be derived by summing the value of peaks near the pitch candidate frequency and integer multiples of the pitch candidate frequency. Pitch candidates corresponding to the correct pitch will tend to have large values for this feature compared to incorrect pitch candidates.

In a similar manner, one skilled in the art will observe that features could also be computed using the time domain, the lag domain of the autocorrelation function, the excitation signal derived by inverse filtering the time domain signal using an LPC model, or any other domain that contains information about the pitch of the signal.

Another important type of feature that can be computed is one that uses past or future pitch candidates in its formulation, which allows important a priori knowledge about the smoothness of a pitch contour to be incorporated into the system. For example, a feature could be defined as

$${x}_{k} ( {t}_{n} ) = \frac{1}{σ \sqrt{2 π}} exp ( - \frac{1}{2} {( \frac{{τ}^{*} ( {t}_{n - 1} ) - {τ}_{k} ( {t}_{n} )}{σ} )}^{2} ) , \qquad ( 1 )$$

where τ*(tₙ₋₁) is the pitch estimate from the last frame, τₖ(tₙ) is the pitch period of the k^{th} pitch candidate from the current frame and σ is width parameter. This feature will have a large value when the current pitch candidate is close in value to the previous pitch estimate, which is more likely for a correct pitch candidate, and a low value when it is significantly different.

While the above formulation is useful, if the pitch is ever estimated incorrectly, then this feature may make it difficult for the algorithm to switch back to the correct pitch. An alternative formulation avoids this problem. Let a feature be defined as

$${x}_{k} ( {t}_{n} ) = {max}_{q} [ {L}_{q} ( {t}_{n - 1} ) \frac{1}{σ \sqrt{2 π}} exp ( - \frac{1}{2} {( \frac{{τ}_{q} ( {t}_{n - 1} ) - {τ}_{k} ( {t}_{n} )}{σ} )}^{2} ) ] , \qquad ( 2 )$$

where L_{q}(tₙ₋₁) is the likelihood that the q^{th} pitch candidate is correct in Is the last frame, as defined above, τ_{q}(tₙ₋₁) is the pitch period of the q^{th} pitch candidate in the last frame, and τₖ(tₙ) is the pitch period of the k^{th} pitch candidate in the current frame, and σ is a width parameter. Therefore, this feature will be large if there is a pitch candidate in the last frame that has a similar pitch period and is likely to be correct, even if the pitch candidate was not actually selected as the pitch estimate for the last frame.

Another type of feature that can be extracted is one that is independent of the pitch candidate and the method used to compute the pitch candidate (e.g. estimated noise level in the signal). In this case, the feature value will be identical for all pitch candidates, which selects a different plane in the feature space, which in turn defines a different likelihood surface, as defined in above Therefore, features of this type can be used to alter the likelihood surface smoothly as a function of some signal property.

The net result of the Feature Extraction block is to produce Q feature vectors {x₁(tₙ), x₂(tₙ), . . . , x_{Q}(tₙ)} for each time instance tₙ, each with dimension M, where for this specific application M is 3 and Q is between 3 and 5.

Likelihood Estimation

The main advantage of this invention over previous methods of performing channel selection is that multiple features can be used, and the multivariate dependencies between the features can be fully modelled and accounted for. The process of evaluating the likelihood that a given pitch candidate is correct involves two processes:

1. The functional form of the likelihood function L(x,α) must be defined on the multi-dimensional feature space, and the parameters α of the likelihood function must be estimated.

2. The likelihood function must be evaluated at the position of each pitch candidate's feature vector L(x_{q}, α) to determine the likelihood that the pitch candidate is correct.

While the second process is straightforward, the first process can take on many different manifestations, since both the functional form of the likelihood function and the method used to estimate the parameters can vary widely. A relatively straightforward approach will be described here, but it should be clear to someone skilled in the art, that there can be many is variations on the theme.

The approach taken in this specific application is to use a Bayesian formulation. Suppose that a pitch candidate is considered correct if its pitch period is within a given tolerance Δτ from the true pitch period, and it is considered incorrect otherwise. Let the correct pitch class be represented symbolically as ω₍₁₎ and the incorrect pitch class be represented as ω₍₀₎. The feature vectors associated with the correct and incorrect pitch candidates have a conditional probability density function (pdƒ) defined by p(x|ω⁽¹⁾) and p(x|ω⁽⁰⁾) respectively, which indicates the probability that a feature vector from each of the classes will have a given value x. The α priori probability that a given pitch candidate is correct p(ω⁽¹⁾) or incorrect p(ω⁽⁰⁾) can be conveniently set to 0.5 for this specific application. Therefore, the unconditional probability density function is given by p(x)=p(ω⁽⁰⁾)p(x|ω⁽⁰⁾)+p(ω⁽¹⁾)p(x|ω⁽¹⁾)=0.5(p(x|ω⁽⁰⁾)+p(x|ω⁽¹⁾)), which indicates the probability that a feature vector will have a value x regardless of the class that it belongs to. The a posteriori probability that a given feature vector belongs to the correct class is then defined using Bayes rule as

$$\begin{matrix}p ( {ω}^{( 1 )} \vert x ) = \frac{p ( {ω}^{( 1 )} ) p ( x \vert {ω}^{( 1 )} )}{p ( x )} & ( 3 ) \\ = \frac{p ( x \vert {ω}^{( 1 )} )}{p ( x \vert {ω}^{( 0 )} ) + p ( x \vert {ω}^{( 1 )} )} , & ( 4 )\end{matrix}$$

where the last equality follows due to the fact that both classes have equal a priori probabilities.

Using this Bayesian formulation, the likelihood that a given pitch candidate is correct can simply be defined as the a posteriori probability (see equation 4) that its corresponding feature vector belongs to the correct class. Some method of estimating the conditional pdƒs is still required, and the total set of parameters used to define them make up the likelihood parameter vector α.

There are many methods that can be used to estimate pdƒs. A convenient method that is used in this specific application is a Gaussian mixture model. In this approach, the pdƒs are defined as

$$p ( x \vert {ω}^{( k )} ) = {\sum }_{r = 1}^{{R}^{( k )}} {A}_{r}^{( k )} G ( {μ}_{r}^{( k )} , {{Σ}^{( k )}}_{r} ) , \qquad ( 5 )$$

where

G(μ, Σ)=(2π)^{-M/2}|Σ|^{-1/2}exp[−0.5(x−μ)^{T}Σ⁻¹(x−μ)] (6)

is a multivariate Gaussian function in an M dimensional space with a mean vector μ and a covariance matrix Σ, and Aᵣ^{(k)} are weights for each Gaussian such that

$${\sum }_{r = 1}^{{R}^{( k )}} {A}_{r}^{( k )} = 1. \qquad ( 7 )$$

The parameters

α={Aᵣ^{(k)},μᵣ^{(k)},Σᵣ^{(k)}},

for k={0, 1}, and r={1, . . . , R^{(k)}} can be estimated in various ways. They can be estimated using expert knowledge, but they can advantageously be estimated using a “learning from data” method, which implies that some form of training data is available for the estimation process. There are two main forms of learning from data, namely ‘batch mode’, where the parameters are estimated in a training phase before the PDA becomes operational, and ‘adaptive mode’, where the parameters are adjusted in real-time while the PDA is operational.

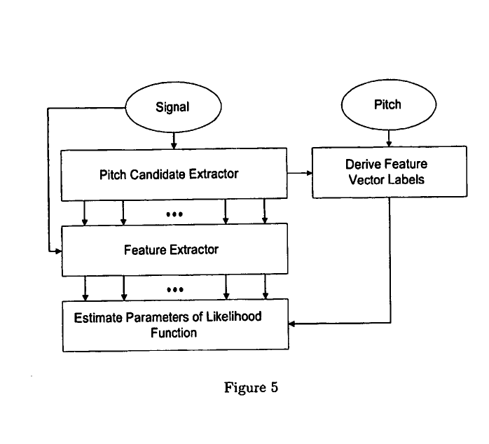

In batch mode (see FIG. 5), training data is available in the form of correctly labelled feature vectors {x[n],y[n]}, for n=1, . . . , N, which can be obtained using a variety of methods. One method of creating training data is to obtain a training signal s(t) and a corresponding pitch signal τ^{c}(t) that is considered to be the correct pitch of s(t) for each instance in time, where regions of the signal s(t) that are not pitched have been clearly marked and are ignored. Several (Q) pitch candidates and their corresponding feature vectors are computed as described above at several (Ñ) instances in time to obtain the following sequences {τ₁(tₙ),τ₂(tₙ), . . . , τ_{Q}(tₙ)}, {x₁(tₙ), x₂(tₙ), . . . ,x_{Q}(tₙ)}, for n=1, . . . ,Ñ. The feature vector labels are determined in the ‘Derive Feature Vector Labels’ block in FIG. 5. The correct pitch is determined using the pitch signal τ^{c}(t) for each of the corresponding time instances tₙ to produce the sequence {τ^{c}(tₙ)}. A pitch candidate τ_{q}(tₙ) is assigned to the correct class, y_{q}(tₙ)=ω⁽¹⁾, if τ_{q}(tₙ) is less than some pre-defined threshold ε from the correct pitch τ^{c}(tₙ) for that time instance, and otherwise the pitch candidate is assigned to the incorrect class, y_{q}(tₙ)=ω⁽⁰⁾. Good results are obtained with a threshold ε=0.6 ms. Each pitch candidate feature vector x_{q}(tₙ) will then have a corresponding label y_{q}(tₙ). Since the order of the pitch candidates and the time sequence is considered unimportant, the training data can be arranged into a single sequence {x[n], y[n]}, for n=1, . . . , N, where N=QÑ.

One way of estimating the parameters of the Gaussian mixture model in batch mode is to use a single Gaussian for the correct class and then manually subdivide the incorrect class into several subclasses. The subclasses can advantageously be defined to be pitch candidates which represent octave errors (e.g. 0.5, 2 and 3 times the correct pitch). It is also useful to define a class ‘other’ that is used for pitch candidates that do not fall into any of the other classes. These pitch candidates can be labelled using the same technique that was used to label pitch candidates corresponding to the correct pitch, as described above. In this case, the conditional pdƒ p(x|ω⁽¹⁾) has only one Gaussian in its mixture, and p(x|ω⁽⁰⁾) has 4 Gaussians in its mixture. It is then straight-forward to estimate the mean and covariance of each Gaussian using standard statistical estimation as

$${μ}_{r}^{( k )} = {( {N}_{r}^{( k )} )}^{- 1} {\sum }_{n = 1}^{{N}_{r}^{( k )}} {x}_{r}^{( k )} [ n ] \qquad ( 8 )$$

and

$${{Σ}^{( k )}}_{r} = {( {N}_{r}^{( k )} - 1 )}^{- 1} {\sum }_{n = 1}^{{N}_{r}^{( k )}} ( {x}_{r}^{( k )} [ n ] - {μ}_{r}^{( k )} ) {( {x}_{r}^{( k )} [ n ] - {μ}_{r}^{( k )} )}^{T} . \qquad ( 9 )$$

Another method of estimating the parameters of the Gaussian mixture models in batch mode without having to manually subclass pitch candidates in the incorrect class is to use a combination of vector quantization (VQ) and the expectation-maximization (EM) algorithm. In this approach, the parameters are estimated separately for each conditional pdƒ p(x|ω⁽⁰⁾) and p(x|ω⁽¹⁾), so the estimation process will only be described for a generic pdƒ

$$p ( x \vert α ) = {\sum }_{r = 1}^{R} {A}_{r} {p}_{r} ( x \vert {μ}_{r} , {Σ}_{r} ) , \qquad ( 10 )$$

where, α={A₁, μ₁, Σ₁, . . . , A_{R}, μ_{R}, Σ_{R}}, represents the parameters of the mixture density function. The α posterior probability of a vector x belonging to a given mixture component can be estimated using Bayes' rule

$$p ( r \vert x , {μ}_{r} , {Σ}_{r} ) = \frac{{A}_{r} {p}_{r} ( x \vert {μ}_{r} , {Σ}_{r} )}{p ( x \vert α )} . \qquad ( 11 )$$

Assuming that there is an initial guess for the mixture parameters α^{g}, and a training set of data {x₁, . . . , x_{N}}, then the EM algorithm updates the mixture estimates as follows

$$\begin{matrix}{A}_{r}^{new} = \frac{1}{N} {\sum }_{i = 1}^{N} p ( r \vert {x}_{i} , {μ}_{r}^{g} , {{Σ}^{g}}_{r} ) , & ( 12 ) \\ {μ}_{r}^{new} = \frac{{\sum }_{i = 1}^{N} {x}_{i} p ( r \vert {x}_{i} , {μ}_{r}^{g} , {{Σ}^{g}}_{r} )}{{\sum }_{i = 1}^{N} p ( r \vert {x}_{i} , {μ}_{r}^{g} , {{Σ}^{g}}_{r} )} , & ( 13 ) \\ {{Σ}^{new}}_{r} = \frac{{\sum }_{i = 1}^{N} p ( r \vert {x}_{i} , {μ}_{r}^{g} , {{Σ}^{g}}_{r} ) ( {x}_{i} - {μ}_{r}^{new} ) {( {x}_{i} - {μ}_{r}^{new} )}^{T}}{{\sum }_{i = 1}^{N} p ( r \vert {x}_{i} , {μ}_{r}^{g} , {{Σ}^{g}}_{r} )} . & ( 14 )\end{matrix}$$

The algorithm proceeds by using the new parameter estimates as a guess for the next epoch, and it eventually stops when a specified stopping condition is met (e.g. a maximum number of epochs). Good results are obtained for this specific application when the maximum number of epochs is set to 1000. The likelihood that the mixture density p(x|α) is responsible for the observed distribution {x₁, . . . , x_{N}} is guaranteed to increase at each epoch.

The initial guess for the parameter estimates is important to make sure that the algorithm converges to a good local maxima. The number R of Gaussians in the mixture must be preselected. Setting R=3 for the correct class, and R=5 for the incorrect class works well for this specific application. A VQ is initially trained with R centers using the LBG algorithm. These centers are used as the first guess for the mean vectors μᵣ of the Gaussians. A width parameter is defined for each center using the RMS Euclidean distance to the P nearest centers

$${σ}_{r} = \sqrt{{\sum }_{p = 1}^{P} \frac{{‖ {µ}_{r} - {µ}_{p} ‖}^{2}}{P}} , \qquad ( 15 )$$

where for this specific application, P=2 for the correct class and P=3 for the incorrect class. A weight is then defined for each sample xᵢ in the dataset with respect to each center as

$${w}_{r} ( {x}_{i} ) = exp ( \frac{- {‖ {x}_{i} - {µ}_{r} ‖}^{2}}{{σ}_{r}^{2}} ) . \qquad ( 16 )$$

This allows a first guess for the covariance matrix of each Gaussian to be estimated as

$${Σ}_{r} = \frac{{\sum }_{i = 1}^{N} {w}_{r} ( {x}_{i} ) ( {x}_{i} - {µ}_{r} ) {( {x}_{i} - {µ}_{r} )}^{T}}{{\sum }_{i = 1}^{N} {w}_{r} ( {x}_{i} )} . \qquad ( 17 )$$

The first guess for the Gaussian weight is estimated as

$${A}_{r} = \frac{{n}_{r}}{{\sum }_{r = 1}^{R} {n}_{r}} , \qquad ( 18 )$$

where nᵣ is the effective number of training samples captured by each Gaussian, which is defined as

$${n}_{r} = {\sum }_{i = 1}^{N} G ( {x}_{i} , {µ}_{r} , {Σ}_{r} ) , \qquad ( 19 )$$

where G(xᵢ, μᵣ, Σᵣ) is a Gaussian function defined in equation 6.

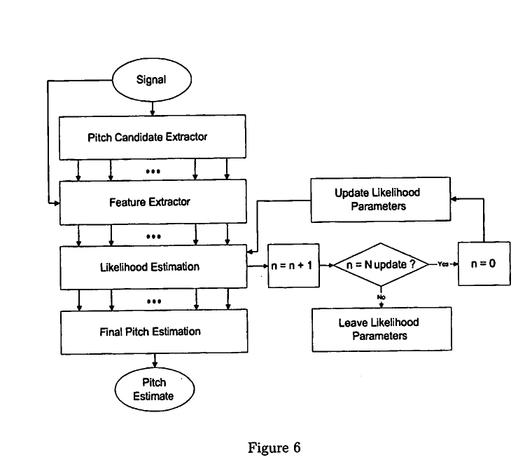

In adaptive mode (see FIG. 6), the parameters are being adjusted in is real-time as the system operates. Therefore, the training data consists of past feature vectors x_{q}(tₙ₋ₖ) and the computed likelihood of whether the pitch candidate belongs to the correct class L(x_{q}(tₙ₋ₖ), α). In this case, a modified version of the EM algorithm can be used to adapt the parameters in α. The algorithm is identical to the EM algorithm described for the batch mode, except that each pitch candidate is used to update the parameters for both the correct class and the incorrect class, but its contribution is weighted with the likelihood L(x_{q}(tₙ₋ₖ), α) for the correct class, and the unlikelihood 1−L(x_{q}(tₙ₋ₖ), α) for the incorrect class. As shown in FIG. 6, the parameters are updated every N_{update} frames, where N_{update}=100 produces good results for this specific application.

An alternative formulation for the likelihood function is to use a neural network approach, where the network has M inputs (i.e. the dimension of the feature vectors) and a single output. The network is trained to produce a 1 at the output if the feature belongs to the correct class, and a 0 if the feature vector belongs to the incorrect class. Typical examples of the types of neural networks that can be used include multilayer perceptron networks, and radial basis function networks.

Final Pitch Estimator

The Final Pitch Estimator block is responsible for selecting a pitch estimate Σ*(tₙ) based on multiple pitch candidates {Σ₁(tₙ), Σ₂(tₙ), . . . , Σ_{Q}(tₙ)} and their likelihood of being correct {L₁(tₙ), L₂(tₙ), . . . , L_{Q}(tₙ)}. A simple but practical method is to select the pitch candidate Σ_{q}(tₙ) with the largest likelihood L_{q}(tₙ)≧Lₖ(tₙ) for all k≠q. However, this approach will only reject gross pitch errors and will not reduce fine pitch errors due to statistical noise. An alternative approach is to discard all pitch candidates below a given likelihood threshold (0.9 works well), and then compute the average or median of the remaining pitch candidates.

1. A method for estimating the pitch of a signal comprising:
determining multiple pitch candidates from said signal.
determining multiple signal features (i.e. a feature vector) for each of the pitch candidates.
estimating the parameters of a likelihood function on the feature space which returns the likelihood that a pitch candidate is correct based on the position of its corresponding feature vector.
determining the likelihood that each pitch candidate is correct by evaluating the likelihood function at the position defined by each of the said pitch candidate's feature vectors.
determining the output pitch to be a function of the individual pitch candidates and their likelihood of being correct.

2. The method of claim 1, where the parameters of the likelihood function are estimated using expert knowledge.

3. The method of claim 1, where the parameters of the likelihood function are estimated using a “learning from data” method.

4. The method of claim 3 where the “learning from data” method operates in an adaptive mode.

5. The method of claim 4, where the adaptive mode uses the EM algorithm to update the parameters of the likelihood function.

6. The method of claim 3, where the “learning from data” method uses labelled training data and operates in batch mode.

7. The method of claim 6, where the training data is obtained using a method comprising:
obtaining a training signal s(t), and a corresponding pitch signal τ^{c}(t) that is considered to be the correct pitch of s(t) for each instance in time, where regions of the signal s(t) that are not pitched have been clearly marked and are ignored.
determining several (Q) pitch candidates and their corresponding feature vectors from the training signal s(t) at several (Ñ) instances in time to obtain the following sequences
{τ₁(tₙ),τ₂(tₙ), . . . ,τ_{Q}(tₙ)},
{x₁(tₙ),x₂(tₙ), . . . ,x_{Q}(tₙ)},
for n=1, . . . , Ñ.
determining the correct pitch using the pitch signal τ^{c}(t) at the same instances in time to produce the sequence {τ^{c}(tₙ)}, for n=1, . . . , Ñ.
assigning a pitch candidate τ_{q}(tₙ) to the correct class y_{q}(tₙ)=ω⁽¹⁾ if it is less than some pre-defined threshold ε from the correct pitch τ^{c}(tₙ) for that time instance, and otherwise assigning the pitch candidate to the incorrect class y_{q}(tₙ)=ω⁽⁰⁾.
ignoring the order of the pitch candidates and the time sequence, and matching each feature vector x_{q}(tₙ) with its corresponding class label y_{g}(tₙ) to form sequence of pairs {x[n],y[n]}, for n=1, . . . , N, where N=QÑ.

8. The method of claim 6, where the batch mode uses a neural network to estimate the parameters of the likelihood function.

9. The method of claim 8, where the functional form of the neural network consists of a multi-layer perceptron network.

10. The method of claim 8, where the functional form of the neural network consists of a radial basis function network.

11. The method of claim 6, where the batch mode uses a Bayesian formulation to define the functional form of the likelihood function as the a posteriori probability of the pitch candidate belonging to the correct class.

12. The method of claim 11, where the pdƒ functions for the correct and incorrect classes are estimated using a density estimation method.

13. The method of claim 12, where the pdƒ functions for the incorrect and correct class are estimated using a Gaussian mixture model.

14. The method of 13, where the parameters of the Gaussian functions in the model are determined completely from the data.

15. The method of 13, where the pdƒ of the correct class is modelled as a single Gaussian, and the pdƒ of the incorrect class is modelled as the sum of three or more Gaussians representing pitch candidates corresponding to 1/2 the correct pitch, 2 times the correct pitch, possibly higher or lower integer multiples, and a catch all class for pitch candidates that correspond to an incorrect pitch but do not fall into one of the pre-defined categories.

16. The method of claim 1, where at least one of the features in the feature vector are computed using a cepstral-domain representation of the signal ƒ_{cep}(τ).

17. The method of claim 16, where the feature is computed for a pitch candidate as the cepstral value at the quefrency given by the pitch candidate ƒ_{cep}(τ_{q}(tₙ)), divided by the maximum value in the cepstrum over a pre-defined range max_{τετ}ƒ_{cep}(τ).

18. The method of claim 16, where the feature is computed for a pitch candidate as the cepstral value at the quefrency given by an integer multiple M of the pitch candidate ƒ_{cep}(M.τ_{q}(tₙ)), or an integer fraction 1/M of the pitch candidate ƒ_{cep}(τ_{q}(tₙ)/M) divided by the maximum value in the cepstrum over a pre-defined range max_{τετ}ƒ_{cep}(τ).

19. The method of claim 1, where at least one of the features in the feature vector are computed using a frequency-domain representation of the signal.

20. The method of claim 1, where at least one of the features in the feature vector are computed using a time-domain representation of the signal.

21. The method of claim 1, where at least one of the features in the feature vector are computed using an autocorrelation-domain representation of the signal.

22. The method of claim 1, where at least one of the features in the feature vector are computed using the excitation signal which results from inverse filtering the signal with a filter from an LPC model.

23. The method of claim 1, where at least one of the features in the feature vector are computed using time-delayed information in the signal.

24. The method of claim 1, where at least one of the features in the feature vector are computed based on measured signal properties that are independent of the pitch candidate and the method used to compute the pitch candidate.

25. The method of claim 1, where the output pitch is computed by first removing all pitch candidates below a pre-defined likelihood level, and then averaging or taking the median of the remaining pitch candidates.
